(19) United States
(12) Patent Application Publication
(10) Pub. No.: US 2012/0287057 A1
(43) Pub. Date: Nov. 15, 2012

(54) GLASS WITH SCULPTED AREA, TOUCH SENSOR DEVICE USING THE SAME, MOLD AND METHOD FOR MAKING THE SAME

(75) Inventor: Kang WEI, Hong Kong (CN)

(73) Assignee: Weis Limited, Kwun Tong (HK)

(21) Appl. No.: 13/170,189

(22) Filed: Jun. 28, 2011

Related U.S. Application Data
(63) Continuation-in-part of application No. 13/104,973, filed on May 10, 2011.

(51) Int. Cl. B32B 3/30; C03B 23/02; G06F 3/041; C03B 23/03

(52) U.S. Cl. 345/173; 428/156; 65/104; 65/173; 65/286

(57) ABSTRACT

The present invention discloses an integrated glass including opposite outer and inner surfaces and a solid sculpted area formed either on the outer surface or the inner surface. The solid sculpted area includes a number of concave shapes or convex shapes which can be used to form letters, numbers or patterns for user decorating or identifying. Besides, a mold for fabricating the integrated glass, a method for making the integrated glass, and a touch sensor device with such integrated glass are also disclosed by the present invention.

### CROSS-REFERENCE TO RELATED APPLICATIONS

This patent application is a continuation-in-part of U.S. patent application Ser. No. 13/104,973, filed on May 10, 2011, entitled “SOLID STRUCTURE GLASS AND METHOD FOR MAKING THE SAME”, which is assigned to the same assignee as this application and is incorporated by reference herein in its entirety.

### BACKGROUND OF THE INVENTION

1. Field of the Invention

The present invention relates to glasses, touch sensor devices using the same, mold and method for making the same, and more particularly, to glasses with sculpted areas applied as cover glasses of display equipments, or outer shells of products, or appearance assemblies of electronic devices, or cover plates of touch devices, or function buttons, or touch panels etc.

2. Description of Related Art

A heat bending glass is produced by heating a glass plate into its softened state and allowing it bending to form non-flat surfaces via kinds of special molds. Such conventional heat bending glass is normally used as a windshield window of a vehicle or as a curved glass of architecture. The glass plate requires reasonable weight when it is heated up to its forming temperature. Usually, the thickness of the glass plate is within the range of 5 mm to 19 mm, and the heat bending glass is downwardly deformed by its own weight, or under the assistants of air pressure or mechanism. Ordinarily, the minimum curvature radius of the conventional heat bending glass is almost 1000 mm. However, out surfaces of the conventional heat bending glasses lack of sculpt areas.

Besides, cover glasses of display equipments, or outer shells of products, or cover plates of touch devices, or function buttons, or touch panels etc. usually use flat glasses which lack of sculpted areas as well. Solid structure glasses manufactured by mechanical processes normally include a recessed top surface and a flat bottom surface. The top surface includes a central flat surface and marginal curved surfaces. However, such manufacture process is complex and it is difficult to fabricate curved glasses with complex configurations. The mold manufacture process is applied for making the curved glasses such as optical components. However, it is only suitable for making the optical components with simple configurations and axial symmetric figures both without sculpt areas.

Hence, an improved glass, a mold for fabricating the glass, a touch sensor device with such glass and a method for making the glass are desired.

### BRIEF SUMMARY OF THE INVENTION

The present invention provides an integrated glass which includes an outer surface, an inner surface opposite to the outer surface and a solid sculpted area formed on the outer surface or the inner surface. The solid sculpted area includes a plurality of concave shapes formed on the outer surface or the inner surface, or a plurality of convex shapes formed on the outer surface or the inner surface. The concave shapes or the convex shapes can be used to form letters, numbers or patterns for user decorating or identifying.

The present invention further provides a mold for manufacturing the above integrated glass. The mold includes a solid sculpted area corresponding to the solid sculpted area of the integrated glass in order to transfer the solid sculpted area of the mold to the integrated glass.

The present invention further provides a touch sensor device including the above integrated glass. The integrated glass includes a touch sensor component area for detecting whether a touch sensor area of the touch sensor device is touched or not.

The present invention further provides a method for making an integrated glass including the following steps:

S1, putting a glass preform into a mold with solid sculpted area;
S2, heating the glass preform and the mold together into a forming temperature of the glass preform under condition that the glass preform is in a softened state;
S3, applying pressure against the mold to squeeze the glass preform so as to transfer a solid sculpted area of the mold to the glass preform and achieve a finished glass;
S4, cooling and annealing the mold and the finished glass to eliminate thermal stress; and
S5, separating the finished glass from the mold to achieve the integrated glass.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a glass with sculpted areas in accordance with a first embodiment of the present invention;

FIG. 2(a) to FIG. 2(h) are schematic cross-sectional views of the glass taken along line A-A of FIG. 1 to illustrate similar varieties;

FIG. 3 is a perspective view of a glass with sculpted areas in accordance with a second embodiment of the present invention;

FIG. 4(a) to FIG. 4(d) are schematic cross-sectional views of the glass taken along line B-B of FIG. 3 to illustrate similar varieties;

FIG. 5 is a perspective view of a glass with sculpted areas in accordance with a third embodiment of the present invention;

FIG. 6(a) to FIG. 6(d) are schematic cross-sectional views of the glass taken along line C-C of FIG. 5 to illustrate similar varieties;

FIG. 7 is a perspective view of a solid structure glass with sculpted areas in accordance with a fourth embodiment of the present invention;

FIG. 8(a) to FIG. 8(d) are schematic cross-sectional views of the solid structure glass taken along line D-D of FIG. 7 to illustrate similar varieties;

FIG. 9(a) to FIG. 9(d) are schematic cross-sectional views of the solid structure glass taken along line E-E of FIG. 7 to illustrate similar varieties;

FIG. 10 is a schematic view of a pair of molds for manufacturing the solid structure glasses;

FIG. 11 is a schematic perspective view of a touch sensor device in accordance with a first embodiment of the present invention;

FIG. 12 is a cross-sectional view of the touch sensor device taken along line F-F of FIG. 11;

FIG. 13 is a schematic perspective view of another touch sensor device in accordance with a second embodiment of the present invention;

FIG. 14 is a cross-sectional view of the another touch sensor device taken along line G-G of FIG. 13;

FIG. 15 is a cross-sectional view of the another touch sensor device taken along line H-H of FIG. 13;

FIG. 16(a) is a perspective view of a solid structure glass with sculpted areas in accordance with a fifth embodiment of the present invention;

FIG. 16(b) is a top view of the solid structure glass as shown in FIG. 16(a);

FIG. 17(a) is a perspective view of a solid structure glass with sculpted areas in accordance with a sixth embodiment of the present invention;

FIG. 17(b) is a top view of the solid structure glass as shown in FIG. 17(a);

FIG. 18(a) is a perspective view of a solid structure glass with sculpted areas in accordance with a seventh embodiment of the present invention;

FIG. 18(b) is a top view of the solid structure glass as shown in FIG. 18(a);

FIG. 19(a) is a perspective view of a solid structure glass with sculpted areas in accordance with an eighth embodiment of the present invention;

FIG. 19(b) is a top view of the solid structure glass as shown in FIG. 19(a);

FIG. 20(a) is a perspective view of a solid structure glass with sculpted areas in accordance with a ninth embodiment of the present invention;

FIG. 20(b) is a top view of the solid structure glass as shown in FIG. 20(a); and

FIG. 21 is a schematic manufacturing flow charts for making a solid structure glass.

### DETAILED DESCRIPTION OF THE PREFERRED EMBODIMENTS

Reference will now be made to the drawing figures to describe the embodiments of the present invention in detail. In the following description, the same drawing reference numerals are used for the same elements in different drawings.

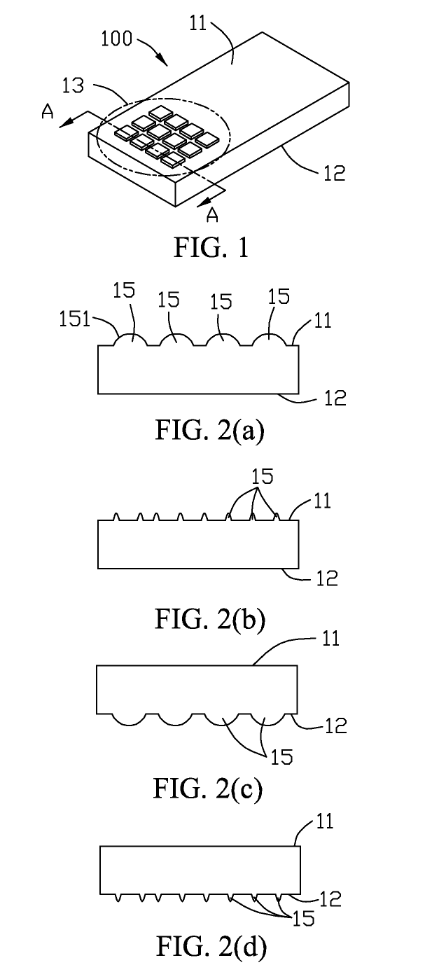

Referring to FIG. 1, the present invention discloses an integrated glass 100 which includes an outer surface 11, an inner surface 12 opposite to the outer surface 11 and a solid sculpted area 13 formed on the outer surface 11 or the inner surface 12 enclosed by a broken circle as shown in FIG. 1.

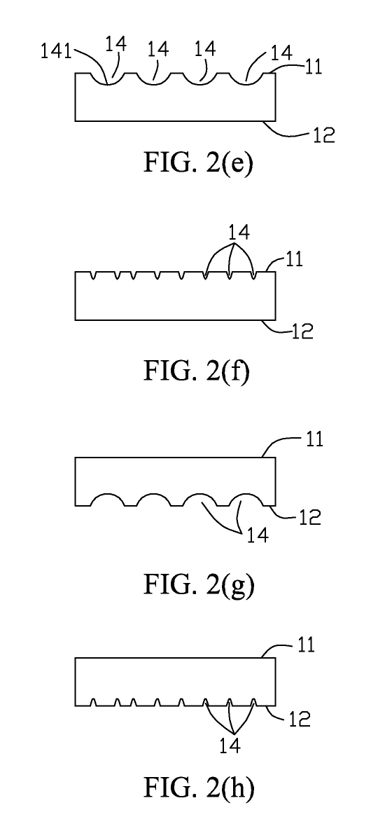

Referring to FIG. 2(a) to FIG. 2(h), the solid sculpted area 13 includes a plurality of concave shapes 14 or convex shapes 15 formed on the outer surface 11 or the inner surface 12 of the solid structure glass 100. Specifically, as shown in FIG. 2(a), the convex shapes 15 protrude beyond the outer surface 11.

As another change of the convex shapes 15 of FIG. 2(a), the convex shapes 15 as shown in FIG. 2(b) also protrude beyond the outer surface 11 though the outlines of the convex shapes 15 of FIG. 2(a) and FIG. 2(b) are different.

As another change of the convex shapes 15 of FIG. 2(a), the convex shapes 15 as shown in FIG. 2(c) protrude beyond the inner surface 12 though the outlines of the convex shapes 15 of FIG. 2(a) and FIG. 2(c) are the same.

As another change of the convex shapes 15 of FIG. 2(b), the convex shapes 15 as shown in FIG. 2(d) also protrude beyond the inner surface 12 though the outlines of the convex shapes 15 of FIG. 2(b) and FIG. 2(d) are the same.

Referring to FIG. 2(e), the concave shapes 14 are recessed from the outer surface 11 of the solid structure glass 100.

As another change of the concave shapes 14 of FIG. 2(e), the concave shapes 14 as shown in FIG. 2(f) are also recessed from the outer surface 11 though the outlines of the concave shapes 14 of FIG. 2(e) and FIG. 2(f) are different.

As another change of the concave shapes 14 of FIG. 2(e), the concave shapes 14 as shown in FIG. 2(g) are recessed from the inner surface 12 though the outlines of the concave shapes 14 of FIG. 2(e) and FIG. 2(g) are the same.

As another change of the concave shapes 14 of FIG. 2(f), the concave shapes 14 as shown in FIG. 2(h) are also recessed from the inner surface 12 though the outlines of the concave shapes 14 of FIG. 2(f) and FIG. 2(h) are the same.

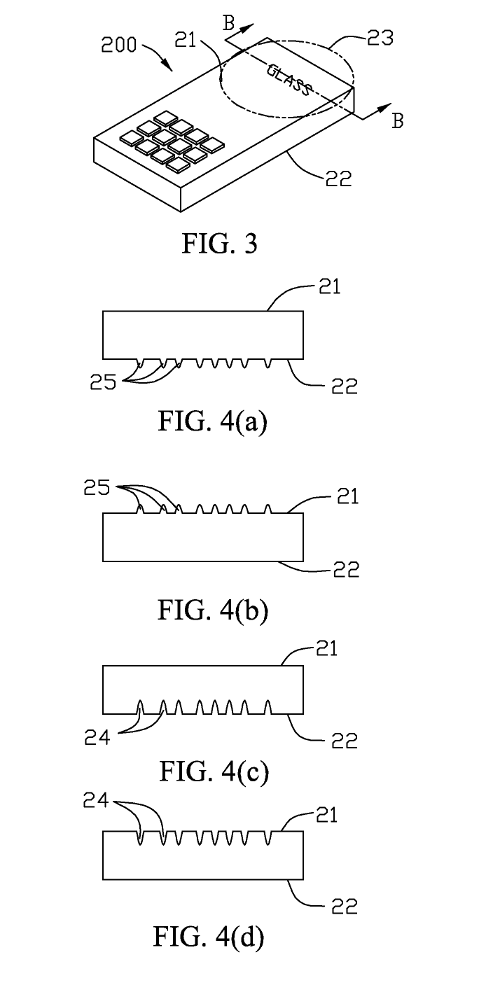

Referring to FIG. 3, the present invention discloses another integrated glass 200 which is similar to the glass 100. The main differences between the glasses 100, 200 are the location of the solid sculpted area and the outlines of the concave shapes and the convex shapes. The glass 200 includes an outer surface 21, an inner surface 22 opposite to the outer surface 21 and a solid sculpted area 23 formed on the outer surface 21 or the inner surface 22 enclosed by a broken circle as shown in FIG. 3.

Referring to FIG. 4(a) to FIG. 4(d), the solid sculpted area 23 includes a plurality of concave shapes 24 or convex shapes 25 formed on the outer surface 21 or the inner surface 22 of the glass 200. The concave shapes 24 or the convex shapes 25 can be used to form letters or numbers representing company names, or product names, or product models for user decorating or identifying. Specifically, as shown in FIG. 4(a), the convex shapes 25 protrude beyond the inner surface 22. Alternatively, the convex shapes 25 can be set to protrude beyond the outer surface 21 as shown in FIG. 4(b). However, as another change of the convex shapes 25 of FIGS. 4(a) and 4(b), the convex shapes 25 can be replaced by the concave shapes 24 recessed from the outer surface 21 or the inner surface 22 as clearly shown in FIGS. 4(c) and 4(d).

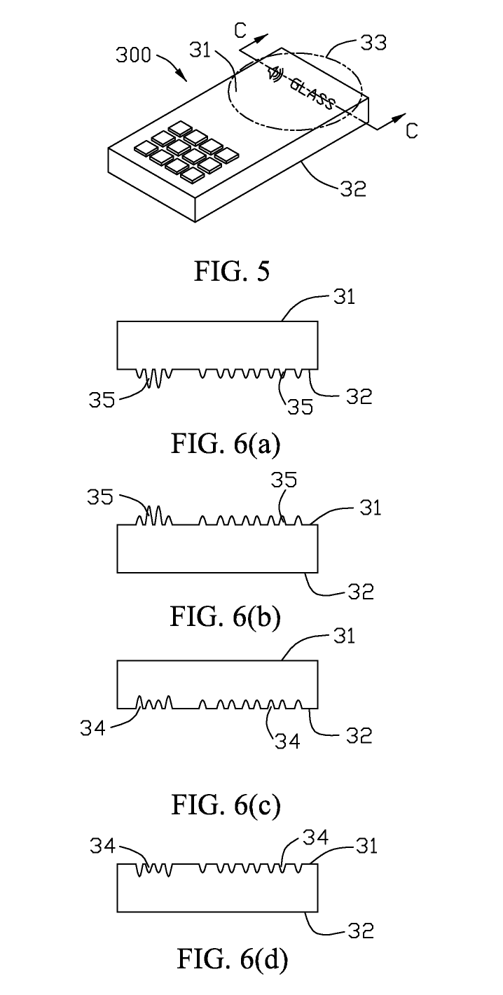

Referring to FIG. 5, the present invention discloses another integrated glass 300 which is similar to the glass 200. The main differences between the glasses 200, 300 are the additional outlines of the concave shapes and the convex shapes to form new patterns. The glass 300 includes an outer surface 31, an inner surface 32 opposite to the outer surface 31 and a solid sculpted area 33 formed on the outer surface 31 or the inner surface 32 enclosed by a broken circle as shown in FIG. 5.

Referring to FIG. 6(a) to FIG. 6(d), the solid sculpted area 33 includes a plurality of concave shapes 34 or convex shapes 35 formed on the outer surface 31 or the inner surface 32 of the glass 300. The concave shapes 34 or the convex shapes 35 can be used to form letters, or numbers, or patterns representing company names, or product names, or product models, or trademarks for user decorating or identifying. Specifically, as shown in FIG. 6(a), the convex shapes 35 protrude beyond the inner surface 32. Alternatively, the convex shapes 35 can be set to protrude beyond the outer surface 31 as shown in FIG. 6(b). However, as another change of the convex shapes 35 of FIGS. 6(a) and 6(b), the convex shapes 35 can be replaced by the concave shapes 34 recessed from the outer surface 31 or the inner surface 32 as clearly shown in FIGS. 6(c) and 6(d).

The glasses 100, 200, 300 are all flat glasses and both the outer surfaces 11, 21, 31 and the inner surfaces 12, 22, 32 are flat surfaces.

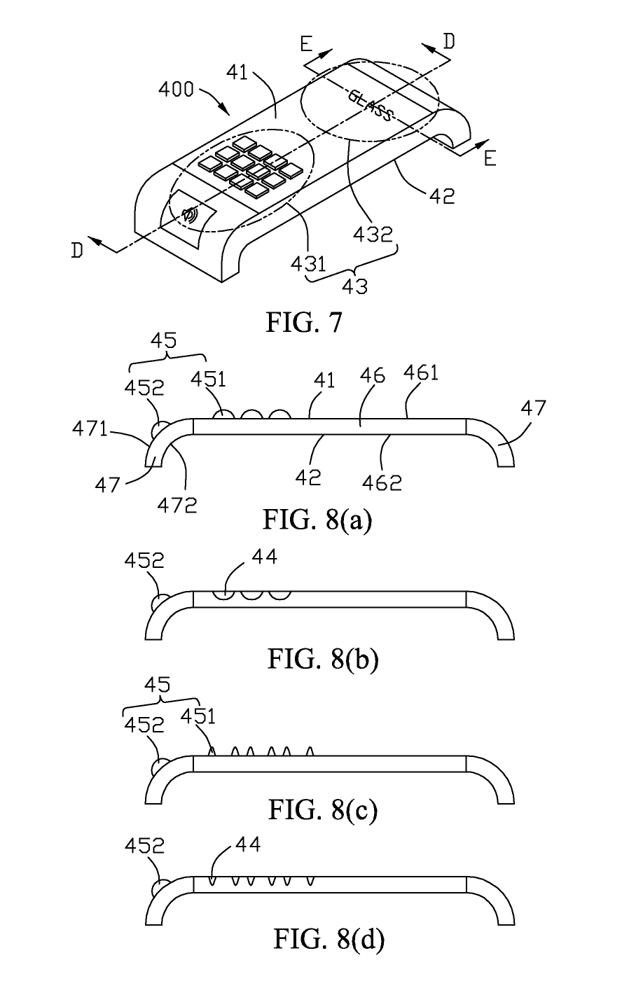

Referring to FIG. 7, the present invention discloses another integrated solid structure glass 400 which includes an outer surface 41, an inner surface 42 opposite to the outer surface 41 and a solid sculpted area 43 formed on the outer surface 41 or the inner surface 42 enclosed by a broken circle as shown in FIG. 7. The solid structure glass 400 includes a first solid sculpted area 431 and a second solid sculpted area 432. Referring to FIG. 8(a), from a view of configuration, the solid structure glass 400 includes a body 46 and a pair of bending portions 47 extending from lateral sides of the body 46. The body 46 includes a first outer surface 461 and a first inner surface 462. Each bending portion 47 includes a second outer surface 471 and a second inner surface 472. The outer surface 41 of the solid structure glass 400 includes the first and the second outer surfaces 461, 471. The inner surface 42 of the solid structure glass 400 includes the first and the second inner surfaces 462, 472. According to the illustrated embodiment of the present invention, the first outer surface 461 and the first inner surface 462 are flat surfaces, and the second outer surface 471 and the second inner surface 472 are curved surfaces. That is to say, the outer surface 41 and the inner surface 42 are both combined of a flat surface and a curved surface. Alternatively, either the outer surface 41 or the inner surface 42 can be combined of a curved surface, or at least two curved surfaces, or a curved surface and at least one flat surface, or at least two flat surfaces. As a result, the solid structure glass 400 can easily be made with different outlines so as to be especially compatible with the form factor of products.

The solid sculpted area 43 is located at the curved surface or the flat surface. Referring to FIG. 7, according to the illustrated embodiment of the present invention, the first solid sculpted area 431 is located at the joint of the curved surface and the flat surface, and the second solid sculpted area 432 are located at the flat surface.

Referring to FIG. 8(a) to FIG. 8(d), the first solid sculpted area 431 includes a plurality of concave shapes 44 or convex shapes 45 formed on the outer surface 41 or the inner surface 42 of the solid structure glass 400. Referring to FIGS. 8(a) and 8(c), the first solid sculpted area 431 is formed on the first outer surface 461 and the second outer surface 471. The first solid sculpted area 431 includes a first convex shapes 451 protruding beyond the first outer surface 461 and a second convex shapes 452 protruding beyond the second outer surface 471. Referring to FIGS. 8(b) and 8(d), the first solid sculpted area 431 includes the concave shapes 44 recessed from the first outer surface 461 and the second convex shapes 452 protruding beyond the second outer surface 471.

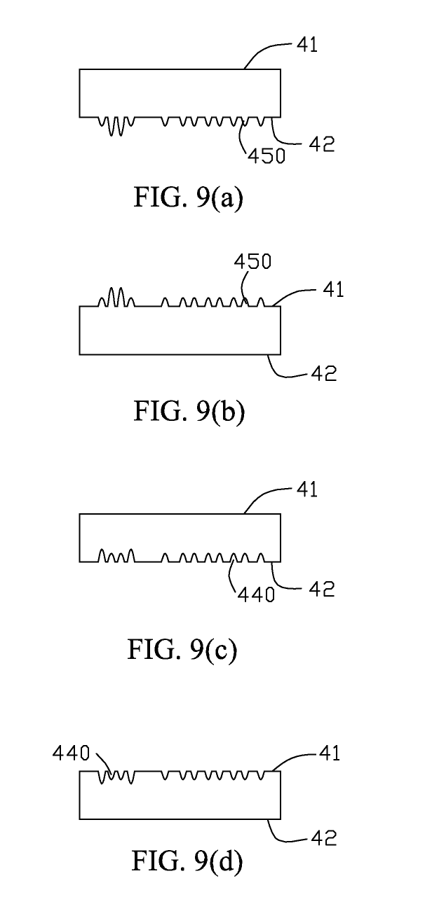

Referring to FIG. 9(a) and FIG. 9(d), the second solid sculpted area 432 includes a plurality of concave shapes 440 or convex shapes 450 formed on the outer surface 41 or the inner surface 42 of the solid structure glass 400. The outlines and the location of the concave shapes 440 and the convex shapes 450 are the same as the concave shapes 34 and the convex shapes 35 of FIGS. 6(a) and 6(d), so that detailed description thereof are omitted herein.

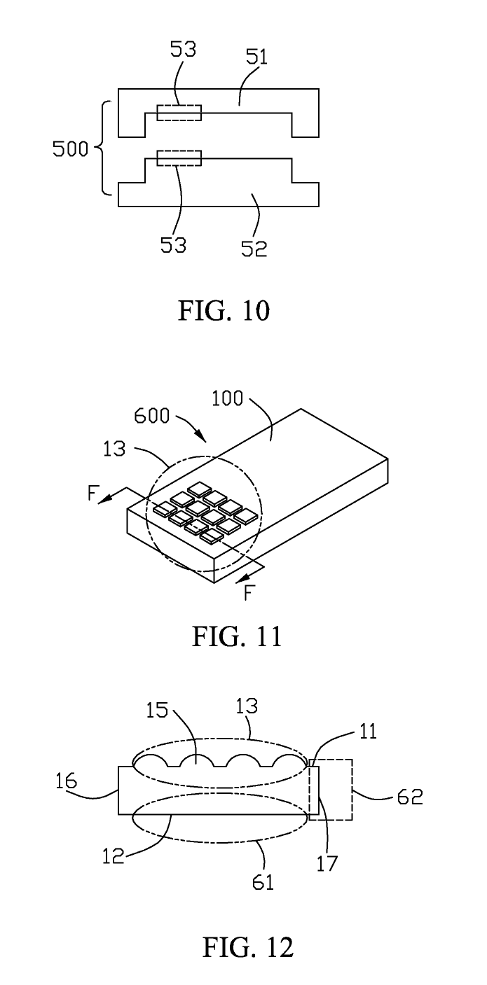

Referring to FIG. 10, the present invention discloses a mold 500 for manufacturing the glasses 100, 200, 300, 400. The mold 500 includes an upper mold 51 with solid sculpted area and a lower mold 52 with solid sculpted area. The upper and the lower molds 51, 52 include a mold solid sculpted area 53 corresponding to the solid sculpted areas 13, 23, 33, 43. The mold solid sculpted area 53 can be separated or replaced or assembled to form different outlines. It is understood that the upper and the lower molds 51, 52 can be integrated formed to be a single mold in an alternative embodiment.

Referring to FIGS. 11 and 12, the present invention further discloses a touch sensor device 600 which includes the glass 100. The glass 100 further includes touch sensor component areas 61, 62 for detecting whether the touch sensor area of the touch sensor device 600 is touched or not. The glass 100 includes a pair of lateral sides 16, 17 between the outer surface 11 and the inner surface 12. The touch sensor component area 61 is located at the inner surface 12 or another board corresponding to the inner surface 12. The touch sensor component area 62 is located at one of the lateral sides 16, 17. Touch sensor components corresponding to the touch sensor component areas 61, 62 can be transparent conductive layers or optical components or any other components with touch sensor function.

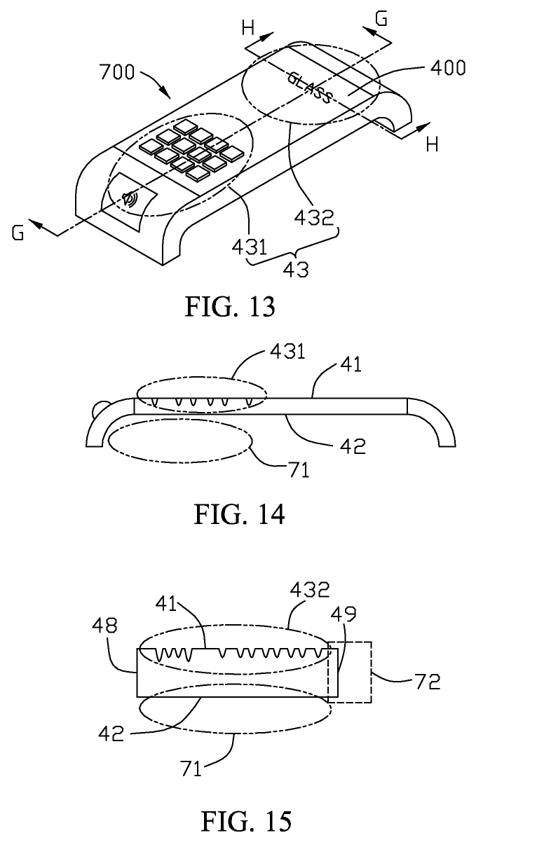

Referring to FIG. 13 to FIG. 15, the present invention further discloses another touch sensor device 700 which includes the integrated solid structure glass 400 as shown in FIG. 7. Besides, the solid structure glass 400 includes touch sensor component areas 71, 72 for detecting whether the touch sensor areas of the touch sensor device 700 are touched or not. The solid structure glass 400 includes a pair of lateral sides 48, 49 between the outer surface 41 and the inner surface 42. The touch sensor component area 71 is located at the inner surface 42 or another board corresponding to the inner surface 42. The touch sensor component area 72 is located at one of the lateral sides 71, 72. Touch sensor components corresponding to the touch sensor component areas 61, 62 can be transparent conductive layers or optical components or any other components with touch sensor function.

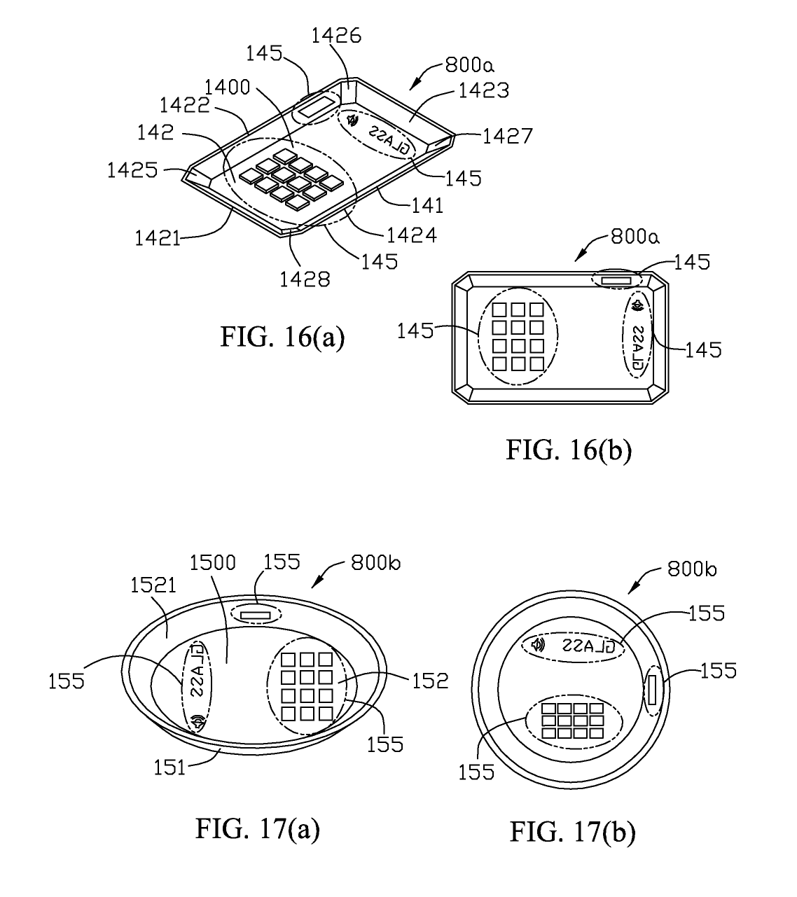

Referring to FIGS. 16(a) and 16(b), the present invention further discloses another integrated solid structure glass 800a according to the fifth embodiment. The solid structure glass 800a includes a polygonal body 1400, a solid sculpted area 145, and eight extending portions 1421, 1422, 1423, 1424, 1425, 1426, 1427, 1428 extending from peripheral sides of the body 1400. Outer and inner surfaces of the body 1400 are flat surfaces, while the eight extending portions 1421 to 1428 are curved. From an integrated view thereof, the outer surface 143 and the inner surface 144 of the solid structure glass 800a are both combined of multiple curved surfaces. Referring to FIG. 16(b), the solid structure glass 800a is polygonal from a top view thereof including but not limited to triangle, quadrangle, pentagon etc. A cross-sectional plane of the solid structure glass 800a is of thin configuration. Curvatures of the curved surfaces are constant and non-zero, or are continuously variational. The continuously variational curvatures are linear or non-linear. It is easy to be understood that the eight extending portions 1421 to 1428 can be flat, alternatively. The solid sculpted area 145 can be the solid sculpted areas 13, 23, 33, 43 as shown in FIGS. 1 to 9(d), alternatively. That is to say, the solid sculpted area 145 includes a plurality of concave shapes or convex shapes formed on the outer surface 143 or the inner surface 144 of the solid structure glass 800a. The concave shapes or the convex shapes can be used to form letters, or numbers, or patterns representing company names, or product names, or product models, or trademarks for decorating or identifying. The solid sculpted area 145 can be located at the flat surfaces or the curved surfaces of the solid structure glass 800a.

Referring to FIGS. 17(a) and 17(b), a sixth embodiment of the present invention discloses an integrated solid structure glass 800b including a body 1500, a solid sculpted area 155 and a torus extending section 1521 extending from peripheral sides of the body 1500. The torus extending section 1521 can be recognized as multiple extending portions linked together. Outer and inner surfaces of the body 1500 are flat surfaces or curved surfaces. Outer and inner surfaces of the extending section 1521 are curved surfaces. From an integrated view thereof, a cross-sectional plane of the solid structure glass 15 is of thin configuration. Curvatures of the curved surfaces are constant and non-zero, or are continuously variational. The continuously variational curvatures are linear or non-linear. Referring to FIG. 17(b), the solid structure glass 800b is round from a top view thereof. It is easy to understand that the geometric figures of the solid structure glass 800b from the top view can be of ellipse, sector or arc, alternatively. Ellipse means that the locus of points for which the sum of the distances from each point to two fixed points is equal. Sector means the portion of a circle bounded by two radii and the included arc. The arc means a segment of a circle. The solid sculpted area 155 can be the solid sculpted areas 13, 23, 33, 43 as shown in FIGS. 1 to 9(d), alternatively. That is to say, the solid sculpted area 155 includes a plurality of concave shapes or convex shapes formed on the outer surface 153 or the inner surface 152 of the solid structure glass 800b. The concave shapes or the convex shapes can be used to form letters, or numbers, or patterns representing company names, or product names, or product models, or trademarks for decorating or identifying. The solid sculpted area 155 can be located at the flat surfaces or the curved surfaces of the solid structure glass 800b.

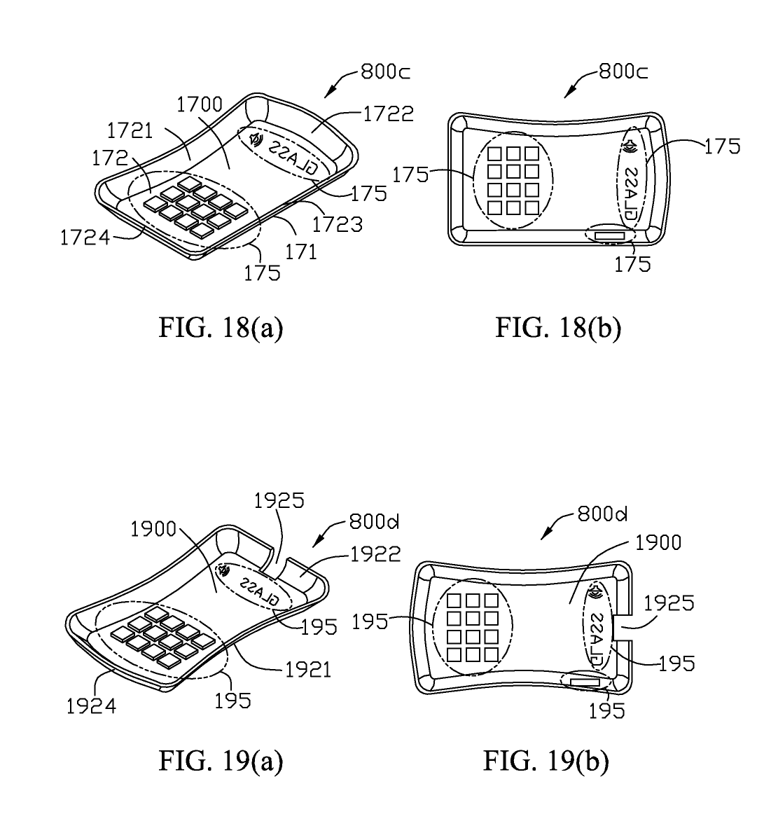

Referring to FIGS. 18(a) and 18(b), a seventh embodiment of the present invention discloses an integrated solid structure glass 800c including a body 1700, a solid sculpted area 175 and four extending portions 1721, 1722, 1723, 1724 integrally extending from peripheral sides of the body 1700. Outer and inner surfaces of the body 1700 are flat surfaces or curved surfaces. Outer and inner surfaces of the extending portions 1721, 1722, 1723, 1724 are curved surfaces. From an integrated view thereof, the outer surface 171 and the inner surface 172 of the solid structure glass 800c are both combined of multiple curved surfaces and a flat surface, or all curved surfaces. Referring to FIG. 18(b), the solid structure glass 800c is unsymmetrical from a top view thereof, so that the solid structure glass 800c is especially compatible with the form factor of products. It is easy to be understood that the solid structure glass 800c can be symmetrical from the top view thereof. The solid sculpted area 175 can be the solid sculpted areas 13, 23, 33, 43 as shown in FIGS. 1 to 9(d), alternatively. That is to say, the solid sculpted area 175 includes a plurality of concave shapes or convex shapes formed on the outer surface 171 or the inner surface 172 of the solid structure glass 800c. The concave shapes or the convex shapes can be used to form letters, or numbers, or patterns representing company names, or product names, or product models, or trademarks for decorating or identifying. The solid sculpted area 175 can be located at the flat surfaces or the curved surfaces of the solid structure glass 800c.

Referring to FIGS. 19(a) and 19(b), an eighth embodiment of the present invention discloses an integrated solid structure glass 800d including a body 1900, a solid sculpted area 195 and four extending portions 1921, 1922, 1923, 1924 integrally extending from peripheral sides of the body 1900. The solid structure glass 800d is similar to the solid structure glass 800c shown in FIGS. 18(a) and 18(b). At least one of the extending portions 1921, 1922, 1923, 1924 defines a cutout 1925 so that the extending portions 1921, 1922, 1923, 1924 are erose. Referring to FIG. 18(b), the solid structure glass 800d is of symmetrical configuration from a top view thereof. The solid sculpted area 195 can be the solid sculpted areas 13, 23, 33, 43 as shown in FIGS. 1 to 9(d), alternatively. That is to say, the solid sculpted area 195 includes a plurality of concave shapes or convex shapes formed on the outer surface or the inner surface of the solid structure glass 800d. The concave shapes or the convex shapes can be used to form letters, or numbers, or patterns representing company names, or product names, or product models, or trademarks for decorating or identifying. The solid sculpted area 195 can be located at the flat surfaces or the curved surfaces of the solid structure glass 800d.

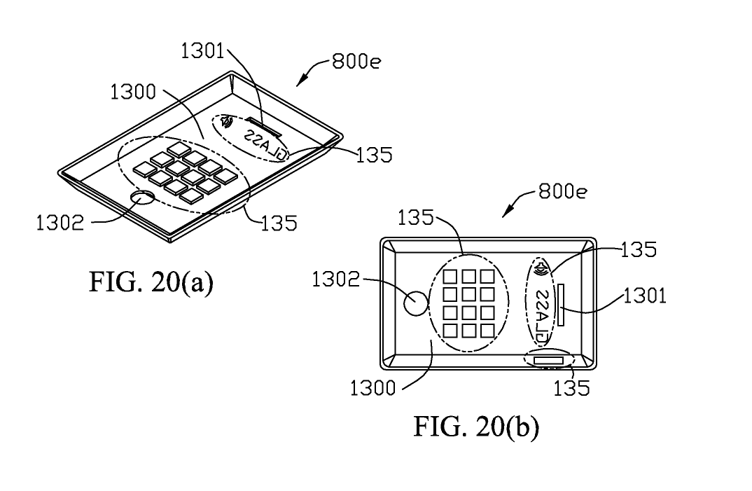

Referring to FIGS. 20(a) and 20(b), a ninth embodiment of the present invention discloses an integrated solid structure glass 800e including a body 1300, a solid sculpted area 135 and four extending portions extending from peripheral sides of the body 1300. Outer and inner surfaces of the body 1300 and the four extending portions are flat. Each angle formed by the body 1300 and each extending portion is within the range of 0 degree to 180 degrees. From an integrated view thereof, the outer surface and the inner surface of the solid structure glass 800e are both combined of multiple flat surfaces. However, the outer surface and the inner surface of the solid structure glass 800e can be curved surfaces. Referring to FIG. 20(b), the solid structure glass 800e is of a quadrangular configuration from a top view thereof. The body 1300 of the solid structure glass 800e defines two through holes 1301 and 1302, among which the through hole 1301 is narrow and elongated, and the through hole 1302 is round. The solid sculpted area 135 can be the solid sculpted areas 13, 23, 33, 43 as shown in FIGS. 1 to 9(d), alternatively. That is to say, the solid sculpted area 145 includes a plurality of concave shapes or convex shapes formed on the outer surface or the inner surface of the solid structure glass 800e. The concave shapes or the convex shapes can be used to form letters, or numbers, or patterns representing company names, or product names, or product models, or trademarks for decorating or identifying. The solid sculpted area 135 can be located at the flat surfaces or the curved surfaces of the solid structure glass 800e.

The above-mentioned glasses 100 to 400 and 800a to 800e can be applied as cover glasses of display equipments, or outer shells of products, or appearance assemblies of electronic devices such as computer, TV box, keyboard, mouse, earphone etc., or cover plates of touch devices, or function buttons, or touch panels etc.

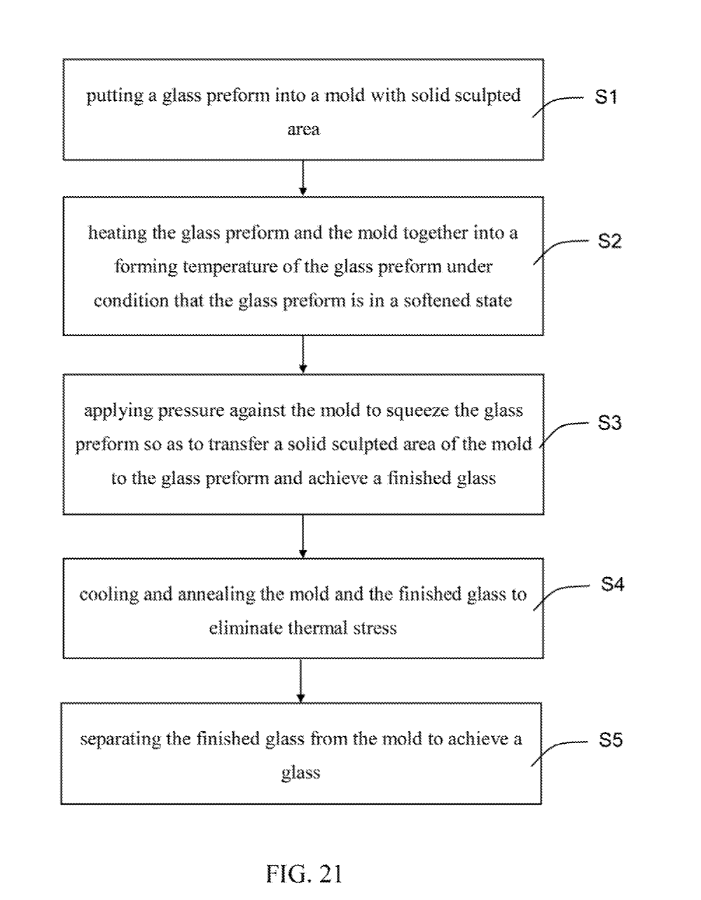

Referring to FIG. 21, a method for making the above-mentioned glasses 100 to 400 and 800a to 800e is disclosed with the following steps:

51, putting a glass preform into a mold with solid sculpted area;
S2, heating the glass preform and the mold together into a forming temperature of the glass preform under condition that the glass preform is in a softened state;
S3, applying pressure against the mold to squeeze the glass preform so as to transfer a solid sculpted area of the mold to the glass preform and achieve a finished glass;
S4, cooling and annealing the mold and the finished glass to eliminate thermal stress; and
S5, separating the finished glass from the mold to achieve the above-mentioned glasses 100 to 400 and 800a to 800e.

The forming temperature in the step S2 is within the range of a glass transition temperature (Tg) and a glass softened temperature (Sp) of the glass preform.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. An integrated glass comprising:
an outer surface and an inner surface opposite to the outer surface; and
a solid sculpted area formed on the outer surface or the inner surface;
wherein
the solid sculpted area comprises a plurality of concave shapes formed on the outer surface or the inner surface, or a plurality of convex shapes formed on the outer surface or the inner surface.

2. The integrated glass as claimed in claim 1, wherein the concave shapes or the convex shapes form letters or numbers or patterns for decorating or identifying.

3. The integrated glass as claimed in claim 1, wherein both the outer surface and the inner surface are flat.

4. The integrated glass as claimed in claim 1, wherein the outer surface comprises a curved surface, or at least two curved surfaces, or a curved surface and at least one flat surface, or at least two flat surfaces; the inner surface comprising a curved surface, or at least two curved surfaces, or a curved surface and at least one flat surface, or at least two flat surfaces.

5. The integrated glass as claimed in claim 4, wherein the solid sculpted area is located at the flat surface or the curved surface.

6. The integrated glass as claimed in claim 5, further comprising a body and a plurality of extending portions integrally extending from the body, a top view of the integrated solid structure glass being polygonal, or round, or elliptic, or sector, or arc, or a free configuration, or a combination thereof.

7. The integrated glass as claimed in claim 4, further comprising a body and at least one bending portion connecting the body, the body comprising a first outer surface and a first inner surface, the at least one bending portion comprising a second outer surface and a second inner surface, the outer surface of the integrated solid structure glass comprising the first and the second outer surfaces, the inner surface of the integrated solid structure glass comprising the first and the second inner surfaces, the solid sculpted area comprising a first solid sculpted area and a second solid sculpted area.

8. The integrated glass as claimed in claim 7, wherein the solid sculpted area is formed on the first outer surface or the second outer surface, the solid sculpted area comprising a plurality of first convex shapes protruding beyond the first outer surface and a plurality of second convex shapes protruding beyond the second outer surface.

9. The integrated glass as claimed in claim 7, wherein the solid sculpted area is formed on the first outer surface or the second outer surface, the solid sculpted area comprising the concave shapes recessed from the first outer surface and a plurality of second convex shapes protruding beyond the second outer surface.

10. The integrated glass as claimed in claim 1, wherein the integrated solid structure glass can be applied as cover glasses of display equipments, or outer shells of products, or appearance assemblies of electronic devices, or cover plates of touch devices, or function buttons, or touch panels.

11. A mold for manufacturing an integrated glass with a solid sculpted area, comprising:
a mold with solid sculpted area corresponding to the solid sculpted area of the integrated glass; wherein
the integrated glass comprising:
an outer surface and an inner surface opposite to the outer surface, the solid sculpted area being formed on the outer surface or the inner surface; wherein
the solid sculpted area comprises a plurality of concave shapes formed on the outer surface or the inner surface, or a plurality of convex shapes formed on the outer surface or the inner surface.

12. The mold as claimed in claim 11, wherein the mold solid sculpted area can be separated or replaced or assembled to form different outlines.

13. The mold as claimed in claim 12, wherein the mold comprises an upper mold, or a lower mold, or a combination of the upper mold and the lower mold.

14. A touch sensor device comprising:
an integrated glass comprising:
an outer surface and an inner surface opposite to the outer surface;
a solid sculpted area formed on the outer surface or the inner surface; and
a touch sensor component area for detecting whether a touch sensor area of the touch sensor device is touched or not; wherein
the solid sculpted area comprises a plurality of concave shapes formed on the outer surface or the inner surface, or a plurality of convex shapes formed on the outer surface or the inner surface.

15. The touch sensor device as claimed in claim 14, wherein the touch sensor component area is located at the inner surface of the integrated glass.

16. The touch sensor device as claimed in claim 14, wherein the touch sensor component area is located at one of the lateral sides of the integrated glass.

17. The touch sensor device as claimed in claim 14, wherein the touch sensor component area is located at another board corresponding to the inner surface of the integrated glass.

18. The touch sensor device as claimed in claim 14, wherein touch sensor components corresponding to the touch sensor component areas can be transparent conductive layers or optical components or any other components with touch sensor function.

19. A method for making an integrated glass comprising the following steps:
S1, putting a glass preform into a mold with solid sculpted area;
S2, heating the glass preform and the mold together into a forming temperature of the glass preform under condition that the glass preform is in a softened state;
S3, applying pressure against the mold to squeeze the glass preform so as to transfer a solid sculpted of the mold to the glass preform and achieve a finished glass;
S4, cooling and annealing the mold and the finished glass to eliminate thermal stress; and
S5, separating the finished glass from the mold to achieve the integrated glass.

20. The method as claimed in claim 19, wherein the forming temperature in the step S2 is within the range of a glass transition temperature (Tg) and a glass softened temperature (Sp) of the glass preform.
